(19) United States
(12) Patent Application Publication
(10) Pub. No.: US 2018/0107978 A1
(43) Pub. Date: Apr. 19, 2018

(54) SYSTEM AND METHOD FOR PROVIDING AUTOMATIC SHIPPING RETURNS

(71) Applicant: Westfield Retail Solutions, Inc., San Francisco, CA (US)

(72) Inventor: Kristopher Joseph Drey, Walnut Creek, CA (US)

(73) Assignee: Westfield Retail Solutions, Inc., San Francisco, CA (US)

(21) Appl. No.: 15/296,860

(22) Filed: Oct. 18, 2016

Related U.S. Application Data
(60) Provisional application No. 62/408,613, filed on Oct. 14, 2016.

(51) Int. Cl. G06Q 10/08; G06Q 20/20; G06Q 10/10

(52) U.S. Cl. CPC G06Q 10/0837; G06Q 10/1093; G06Q 20/204

(57) ABSTRACT

Disclosed are systems and method for providing automatic return shipping. In one embodiment, the method comprises receiving a purchase request, the purchase request including an identification of a product and a user identifier; generating a return label upon receiving the purchase request; providing the return label to a user; receiving a return item from a user, wherein the return item includes the return label; scanning the return label to determine a merchant identification, wherein the merchant identification includes a location of the merchant; and delivering the return item to the merchant based on the location of the merchant.

### CLAIM OF PRIORITY

The present application claims the benefit of the filing date of Prov. U.S. Pat. App. Ser. No. 62/408,613, filed on Oct. 14, 2016, the entire disclosure of which application is hereby incorporated herein by reference.

### COPYRIGHT NOTICE

This application includes material that may be subject to copyright protection. The copyright owner has no objection to the facsimile reproduction by anyone of the patent disclosure, as it appears in the Patent and Trademark Office files or records, but otherwise reserves all copyright rights whatsoever

### BACKGROUND

The present disclosure relates to the field of electronic commerce and specifically to automated return processing.

Currently, many e-commerce sites such as Zappos or Amazon provide automatic returns for orders placed online. Generally, after purchasing an item, a user may manually request a return label, print the label, and return the item for a refund. Despite being utilized by e-commerce sites, brick and mortar retailers do not provide such automatic return functionality. In contrast, users who purchase items at brick and mortar stores are required to physically return to the store to return any unwanted items.

Brick and mortar stores' inability to provide automatic returns results in numerous negative side effects to the businesses operating the stores. Businesses operating physical storefronts generally realize lower profits as customers as more hesitant to purchase items knowing that returning the item if it is unwanted will be overly onerous and require subsequent trips. Additionally, customers are more reluctant to visit such stores and make additional purchases because of the time consumed if a return is desired. Finally, by requiring in-person returns, brick and mortar stores are foreclosed from using data regarding returns to fine tune product offers and learn more about customers likes and dislikes.

### BRIEF SUMMARY

To remedy the aforementioned deficiencies, the disclosure presents systems, methods, and devices for providing automatic shipping returns to brick and mortar stores.

In one embodiment, the disclosure describes a method for providing automatic return shipping. In one embodiment, the method comprises receiving a purchase request, the purchase request including an identification of a product and a user identifier; generating a return label upon receiving the purchase request; providing the return label to a user; receiving a return item from a user, wherein the return item includes the return label; scanning the return label to determine a merchant identification, wherein the merchant identification includes a location of the merchant; and delivering the return item to the merchant based on the location of the merchant.

In one embodiment, the disclosure describes a system for providing automatic return shipping. In one embodiment, the system includes an order management system configured to receive a purchase request, the purchase request including an identification of a product and a user identifier; generate a return label upon receiving the purchase request; provide the return label to a user; and receive a return item from a user, wherein the return item includes the return label. The system may further include a scanner communicably coupled to the order management system configured to scan the return label to determine a merchant identification, wherein the merchant identification includes a location of the merchant; and schedule the delivery of the return item to the merchant based on the location of the merchant

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a network diagram illustrating a system for providing automatic shipping returns according to some embodiments of the disclosure.

FIG. 2 is a physical diagram illustrating a mobile device for providing automatic shipping returns according to some embodiments of the disclosure.

FIG. 3 is a logical block diagram illustrating a retail network for providing automatic shipping returns according to some embodiments of the disclosure.

FIG. 4 is a flow diagram illustrating a method for providing automatic shipping returns according to some embodiments of the disclosure.

FIG. 5 is a flow diagram illustrating a method for initiating and processing automatic shipping returns according to some embodiments of the disclosure.

FIG. 6 is a flow diagram illustrating a method for handling automatic shipping returns according to some embodiments of the disclosure.

FIG. 7 is an illustration of a return package with embedded shipping return labelling according to some embodiments of the disclosure.

### DETAILED DESCRIPTION

The present disclosure relates to systems and methods for providing automated return shipping in, for example, a traditional retail setting. The embodiments illustrated describe a method to provide free shipping returns to customers of brick and mortar retail stores by automatically generating return packaging (e.g., packaging including return labels) upon the in-person purchases of goods. Alternatively, methods are disclosed which allow for the generation of return labels after in-person purchases, e.g., using a mobile application. In each embodiment, the method allows for user to make in-person purchases (e.g., at physical stores) and conveniently obtain return packaging (e.g., in person or via a network-based application) without the need for the user to return to the store to return items. In addition to facilitating the preparation of return packaging, the methods describe systems for handling return items using automated robotic delivery devices. By using robotic delivery devices, the method can quickly delivery return items directly to retail stores, further eliminating wasteful in-person returns.

In some embodiments, the disclosure additionally describes return packaging suitable for implementing the above methods. In some embodiments, a return package includes a pre-printed label affixed to a bag or box which may additionally be used to package goods upon purchase. The packaging includes an adhesive portion which allows a user to re-package any items for return and conveniently mail the item in the same packaging used during purchase.

The present disclosure will now be described more fully hereinafter with reference to the accompanying drawings, which form a part hereof, and which show, by way of illustration, certain example embodiments.

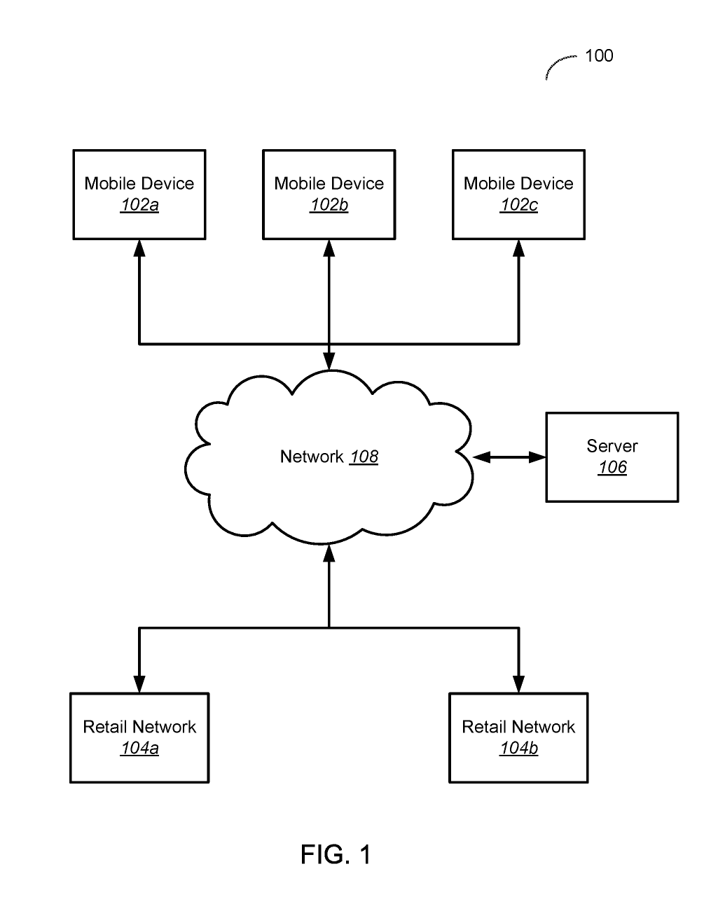

FIG. 1 is a network diagram illustrating a system for providing automatic shipping returns according to some embodiments of the disclosure. As illustrated in FIG. 1, the system 100 includes mobile devices 102a-c, retail networks 104a-b, server 106, and network 108.

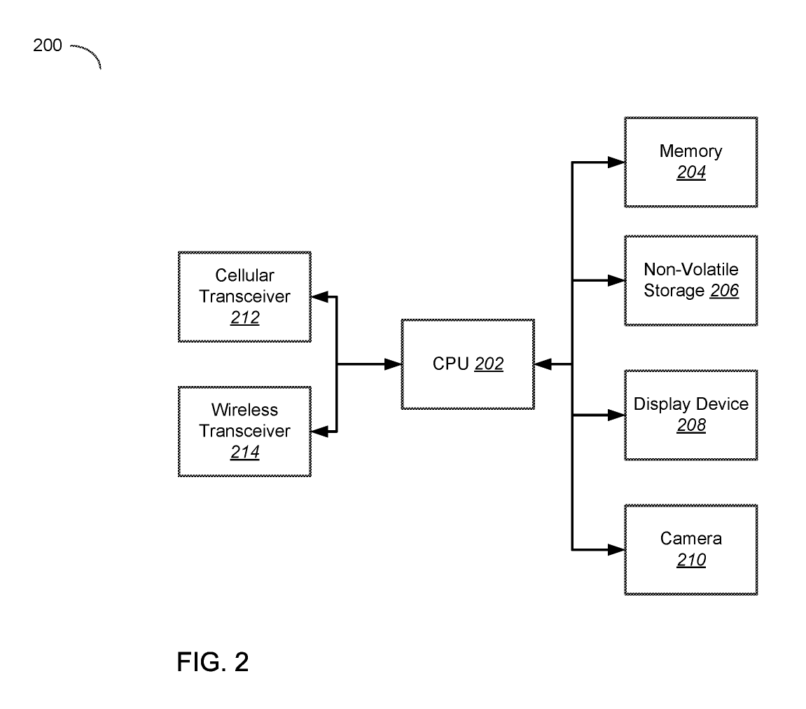

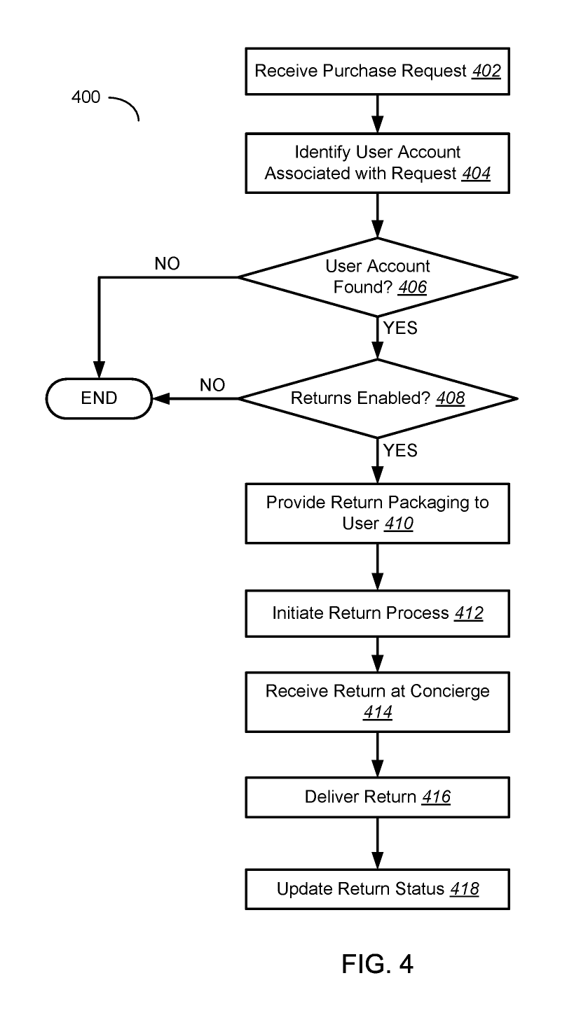

As illustrated in FIG. 1, a mobile devices 102a-c may comprise computing devices designed to be carried by a user. In one embodiment, the mobile devices 102a-c may include hardware devices such as those illustrated in FIG. 2. In one embodiment, mobile device 102a-c may each be equipped with one or more applications to enable shopping and returns of purchased items as described more fully in connection with FIGS. 4 through 6. In some embodiments, mobile device 102a-c may comprise mobile phones, tablets devices, portable computers. In alternative embodiments, mobile device 102a-c may additionally include desktop computers where mobile functionality is not required.

Mobile devices 102a-c may communicate with server 106 and retail networks 104a-b via a network 108. Although illustrated as a single network, network 108 may comprise multiple networks facilitating communication between devices. In one embodiment, the network 108 may include a wireless fidelity (“Wi-Fi”) network as defined by the IEEE 802.11 standards or equivalent standards. In one embodiment, network 108 may comprise the global Internet. In alternative embodiments, network 108 may comprise a wireless network provided by a retail center.

Retail networks 104a-b are connected to network 108. In one embodiment, retail networks 104a-b may comprise a network of computing devices owned and/or operated by a retailer. In one embodiment, retail networks 104a-b may comprise a computer network present within a shopping center or mall. In alternative embodiments, retail networks 104a-b may comprise a network owner or operated by an individual store or chain of stores. Retail networks 104a-b may be configured to receive information from mobile device 102a-c. In one embodiment, retail networks 104a-b may receive information regarding orders (e.g., purchases) and returns from mobile device 102a-c. For example, mobile devices 102a-c may be equipped with an application allowing users of mobile device 102a-c to initiate transactions with retailers operating retail networks 104a-b. Alternatively, or in conjunction with the foregoing, retail networks 104a-b may be configured to receive information regarding returns of orders from mobile devices 102a-c.

Additionally, retail networks 104a-b may be configured to transmit data to mobile devices 102a-c. In one embodiment, retail networks 104a-b may transmit information regarding orders (e.g., status, items ordered, etc.) to applications running on mobile devices 102a-c. Retail networks 104a-b may additionally be configured to transmit return information to mobile devices 102a-c. For example, retail networks 104a-b may be configured to transmit return shipping labels to mobile devices 102a-c. Retail networks 104a-b may additionally be configured to transmit notifications to mobile devices 102a-c. For example, retail networks 104a-b may transmit notifications regarding shipment status or return status to mobile devices 102a-c.

System 100 may additionally include a server 106. In one embodiment, server 106 may be owned or operated by an entity separate from the owner or operator of retail networks 104a-b. Alternatively, or in conjunction with the foregoing, server 106 may be owned or operated by a parent entity of the owners or operators of retail networks 104a-b. In one embodiment, server 106 may manage transactions between mobile devices 102a-c and retail networks 104a-b. For example, server 106 may be responsible for managing analytics and logging information transmitted between mobile devices 102a-c and retail networks 104a-b. Although illustrated as a single device, server 106 may comprise multiple servers located in multiple regions.

FIG. 2 is a physical diagram illustrating a mobile device for providing automatic shipping returns according to some embodiments of the disclosure. The device 200 includes a CPU 202, memory 204, non-volatile storage 206, display device 208, camera 210, cellular transceiver 212 and wireless transceiver 214.

In the illustrated embodiment, device 200 may store one or more applications within memory 204 or non-volatile storage 206. In one embodiment, applications may include a shopping application designed to facilitate purchases from retailers and returns of products purchased from retailers. Applications stored in memory 204 or non-volatile storage 206 may be executed by CPU 202 and displayed via display device 208.

Device 200 additionally includes a camera 210. In one embodiment, camera 210 may comprise any device designed to capture image or video data. Alternatively, or in conjunction with the foregoing, camera 210 may include additional capture devices designed to scan or otherwise capture data. For example, camera 210 may additionally include a barcode scanner, QR code scanner, or similar devices.

In one embodiment, applications running on CPU 202 may allow an operator of the device to utilize camera 210 to “scan” products and or labels. For example, applications may allow the device 200 to utilize camera 210 to scan barcodes associated with products. In this embodiment, CPU 202 may contain logic to convert an image of a barcode into a structured representation of the barcode and may communicate with memory 204 or non-volatile storage 206 to retrieve product and order details associated with the barcode contents. Alternatively, or in conjunction with the foregoing, CPU 202 may retrieve product and order details from a remote source via cellular transceiver 212 or wireless transceiver 214.

As illustrated in FIG. 2, device 200 includes cellular transceiver 212 and wireless transceiver 214. As discussed in connection with FIG. 1, cellular transceiver 212 enables the device 200 to transmit and receive product, return, and order information via a mobile or radio network. For example, cellular transceiver 212 and wireless transceiver 214 may enable CPU 202 to request product, return, and order information associated with a user of a device from a remote source (e.g., a remote server).

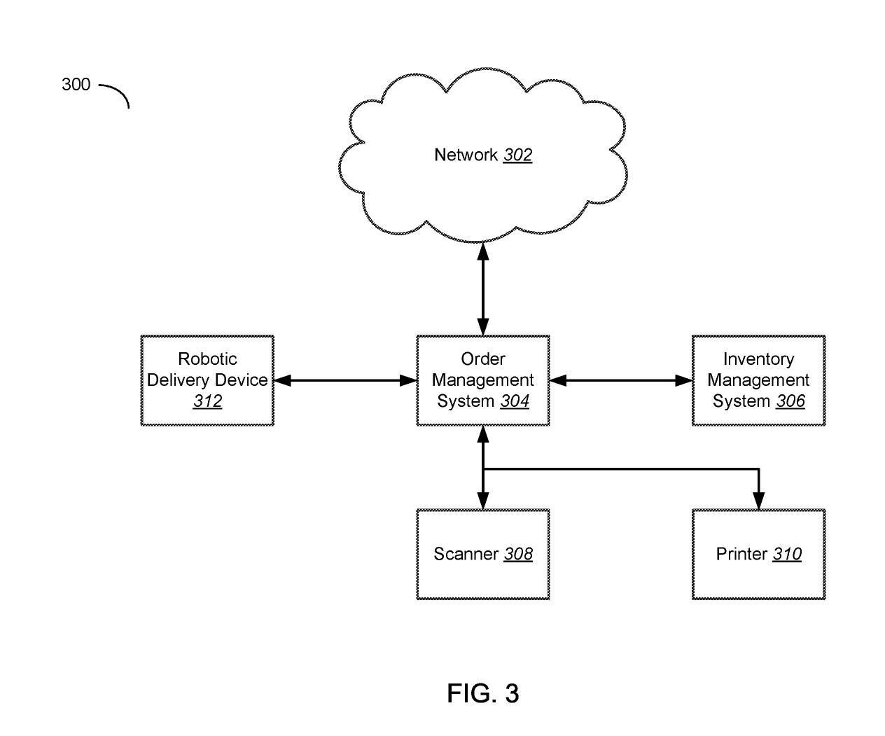

FIG. 3 is a logical block diagram illustrating a retail system for providing automatic shipping returns according to some embodiments of the disclosure. As illustrated in FIG. 3, a system 300 includes a network 302, order management system 304, inventory management system 306, scanner 308, printer 310, and robotic delivery device 312.

In the illustrated embodiment, order management system 304 may comprise one or more servers and databases configured to track and process orders received from customers or merchant locations via network 302. In one embodiment, order management system 304 may be installed at a centralized location. Alternatively, order management system 304 may be installed at individual merchant locations or at individual retail centers. In the illustrated embodiment, order management system 304 may include one or more relational databases storing information regarding customers, users, and orders. Order management system 304 may include user account databases operative to store information regarding customers such as names, email addresses, membership levels, order histories, and return histories. In some embodiments, order management system 304 may be configured to process return requests received from customers as described more fully in connection with FIGS. 4-6.

System 300 may additionally include inventory management system 306 which may comprise one or more servers and databases configured to store information regarding the products offered for sale by one or more merchants. In one embodiment, inventory management system 306 may store details regarding products including, but not limited to, universal product codes, stock amounts, product weights, prices, and the like. Order management system 304 may be configured to communicate via inventory management system 306 via a network (not illustrated). Specifically, order management system 304 may be configured to retrieve product details associated with orders in response to return requests received via network 302. For example, order management system 304 may be configured to update inventory amounts upon receiving return items.

System 300 additionally includes a scanner 308 and a printer 310. Although illustrated as single devices scanner 308 and printer 310 may comprise multiple scanners and printers. In some embodiments, scanner 308 and printer 310 may be communicatively coupled to additional devices such as point of sale terminals. In these embodiments, the additional devices may facilitate communications between scanner 308, printer 308 and order management system 304.

In one embodiment, scanner 308 may comprise an optical scanner capable capturing images of, for example, return labels. In this embodiment, scanner 308 may forward captured information to order management system as described in more detail with respect to FIGS. 4 through 6. In alternative embodiments, scanner 308 may comprise a barcode scanner.

Printer 310 may comprise any suitable print device such as a laser or inkjet printer. In the illustrated embodiment, order management system 304 may be transmit return labels to printer 310 as described in more detail with respect to FIGS. 4 through 6

System 300 additionally includes a robotic delivery device 312. In one embodiment, robotic delivery device 312 may comprise a motorized computing device capable of transporting packages from one location to another. In one embodiment, robotic delivery device 312 may additionally be capable of determining a merchant based on the return packaging and calculating a route to the merchant utilizing a map.

FIG. 4 is a flow diagram illustrating a method for providing automatic shipping returns according to some embodiments of the disclosure.

In step 402, the method 400 receives a purchase request. In one embodiment, receiving a purchase request may comprise receiving product information (e.g., a barcode or other identifier) and a user identifier associated with the purchaser. In one embodiment, purchase requests may be received over a network (e.g., via a mobile application or website). In this embodiment, a purchase request may include a unique identifier for a product and a unique user identifier. In alternative embodiments, receiving a purchase request may comprise scanning a barcode associated with a product at a retail store and receiving user information from the user. For example, user information may include a user identifier encoded on a membership card. Alternatively, user information may include a user identifier provided by a mobile application presented to the retail store during a transaction. Alternatively, user information may include a user identifier associated with a credit card used for payment at a retail store. Alternatively, user information may include a user identifier entered by a user into a terminal during a checkout procedure.

In step 404, the method 400 identifies a user account associated with the purchase request. In one embodiment, the method 400 may utilize the user identifier to query a database of user accounts. In one embodiment, user accounts may be stored by a retail system or by a third party system. In one embodiment, user accounts may store additional information regarding the user such as past purchases, past returns, favorite stores, favorite products, or any other information related to the user's commercial activity. In some embodiments, a user account may additionally indicate a membership “level” or plan of the user, the membership level indicating a user membership enrollment. In this embodiment, a retailer or third party may provide multiple levels of membership plans for users, each membership plan providing various benefits. For example, one membership level may allow for free return processing in exchange for a monthly or annual membership fee. As a second example, one membership level may provide periodic coupons or sale information not provided to other membership plans. Additionally, one membership level may comprise a base level, wherein the plan provides no benefits but is used primarily to store user account information and past commercial activity.

In step 406, the method 400 determines where a user account was identified. In one embodiment, if the method 400 is unable to determine a user account associated with the purchase request the method 400 may end. In this embodiment, the method 400 may determine that since a user account was not identified, the user requesting the purchase is not entitled to automatic return shipping. In alternative embodiments, the method 400 may enable return shipping but may provide return shipping at a cost to the user.

In step 408, the method 400, after identifying a user account, the method 400 determines whether returns are enabled for the user account. In one embodiment, determining whether returns are enabled for the user account may comprise inspecting the user account to ascertain a membership level associated with the account. In one embodiment, the method 400 may determine whether the identified membership level is associated with returns. For example, as discussed previously, some membership levels may allow for automatic returns while others may not. If the method 400 determines that the membership level associated with the user account does not allow for automatic returns, the method 400 may end. In alternative embodiments, the method 400 may enable return shipping but may provide return shipping at a cost to the user. In alternative embodiments, the method 400 may further prompt the user to upgrade their membership plan in order to proceed with the method 400.

In alternative embodiments, the method 400 may additionally determine whether the merchant receiving the purchase request is enrolled in a free shipping plan. Specifically, a merchant may comprise a retail store present within a shopping center or mall. In this embodiment, automatic shipping returns may be provided by the shopping center itself and thus the shopping center may limit the merchants who may participate in the automatic shipping returns provided by the shopping center. In one embodiment, the method 400 may determine whether the merchant receiving the purchase request is enrolled in a revenue sharing plan with the shopping center. In this embodiment, the method 400 may end if the method 400 determines that the merchant is not enrolled in a revenue sharing plan with the shopping center.

In step 410, the method 400 provides return packaging to the user associated with the user account upon determining that the user account supports automatic returns.

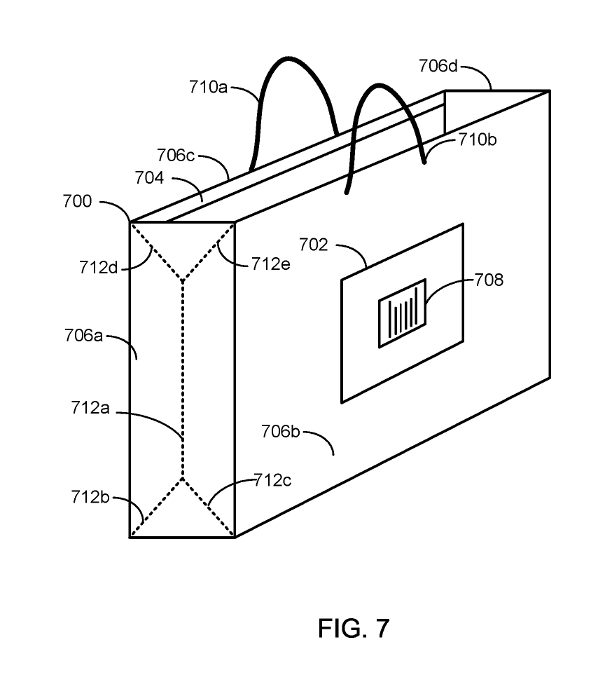

In one embodiment, return packaging may be provided to the user at a point of sale. In this embodiment, return packaging may comprise a return label printed by the merchant at a point of sale using a printer device. Alternatively, or in conjunction with the foregoing, return packaging may comprise a bag or box with a pre-printed return label that is used to house purchases as well as enable returns. An exemplary bag is illustrated in more detail with respect to FIG. 7. In this embodiment, the user may be provided with a bag or box dependent on the weight of the product. In some embodiments, retailers may be provided with bags or boxes having pre-printed return labels in varying sizes.

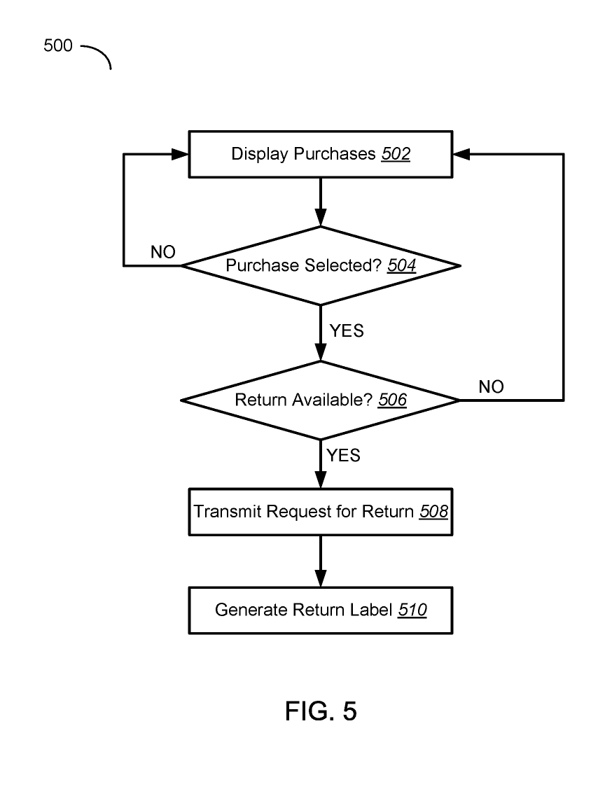

Alternatively, or in conjunction with the foregoing, providing return packaging may comprise transmitting a request to a server storing the user account and updating the user account to include a return label. For example, upon completion of a purchase the method 400 may transmit a notification of the purchase to an order management system which stores a user's purchases and associates these purchases with a user account. In addition, the method 400 may request that the purchase be associated with a return shipping label and the order management system may generate a return label and store the label for subsequent retrieval by the user. Users may then, at a later date, retrieve the return label from the server storing the user account and order information and process returns as discussed more fully in connection with FIG. 5.

In each of the aforementioned embodiments, return packaging (and return labels) may be generated based on the product purchases. For example, in one embodiment, the method 400 may generate return packaging based on the average weight of products sold by a merchant, or sold globally. Generally, return packaging and labels must be generated to enable the shipment of a return based on the weight of the product being returned. In this embodiment, the method 400 may utilize an average weight based on a merchant's inventory to generate the appropriate return packaging. That is, merchants selling lighter items (e.g., clothing) may be associated with a lower average return packaging cost than merchants selling heavier items (e.g., furniture stores). Thus, the method 400 may query an order management system to determine the average weight of products for a merchant prior to generating return packaging.

In alternative embodiments, the method 400 may weigh individual items to accurately calculate return packaging costs. For example, a merchant may be equipped with a scale in order to weigh items prior to requesting return packaging. In this embodiment, the method 400 may utilize the actual weight of the item to generate an exact cost of the return packaging.

In alternative embodiments, the method 400 may utilize known weights of items in generating return packaging. In this embodiment, a inventory management system may store information regarding all products sold by a merchant, including product weights. Thus, the method 400 may detect the identity of the product and transmit the identity to the inventory management system (via an order management system) in order to obtain the weight of the product prior to generating the return packaging.

In alternative embodiments, the method 400 may enable users to scan a barcode of a product after purchasing the product. In this embodiment, the method 400 may transmit the barcode information to a server, wherein the server may confirm that the user has purchased the item associated with the barcode. The server may then transmit a request for return packaging to a centralized concierge. The concierge may then prepare return packaging for the user and provide return packaging to the user. In alternative embodiments, return packaging and labels may be transmitted to the user directly via SMS or e-mail.

Although illustrated as being performed by a merchant, step 410, may alternatively be performed by a separate entity such as a shopping center concierge.

In step 412, the method 400 initiates a return process. In one embodiment, initiating a return process may comprise receiving an indication from a user that a return is requested. The initiation of a return process may be performed by a mobile application. Specifically, a user may utilize a mobile application to obtain a list of purchases. Upon receiving the list of purchases the user may select an item and transmit a request for return processing to an order management system. In one embodiment, the mobile application only enables return processing of items if an item is associated with return packaging as discussed previously.

In step 414, the method 400 receives the return item at a shopping center concierge. In one embodiment, a shopping center concierge may comprise a non-merchant entity located within a shopping center and capable of receiving return items from users. In this manner, returns may be processed by a single entity to avoid duplication of return processing equipment.

In step 416, the method 400 delivers the return item. In one embodiment, delivering a return item may comprise transporting the item from a concierge location to a merchant location. In one embodiment, delivery of return items may be performed by a robotic delivery device. In one embodiment, a robotic delivery device may comprise a motorized computing device capable of transporting packages from one location to another. In one embodiment, the robotic delivery device may additionally be capable of determining a merchant based on the return packaging and calculating a route to the merchant utilizing a map. An example of a robotic delivery device is described more fully in commonly owned application Ser. No. 14/946,635, entitled “ROBOTIC SYSTEMS AND METHODS,” the disclosure of which is incorporated herein in its entirety.

In step 418, the method 400 updates a return status. In one embodiment, the method 400 may receive an indication from the robotic delivery device that a return item has been received by the merchant who sold the product. In one embodiment, a merchant may utilize a display device on the robotic delivery device to accept delivery and complete the return process. In alternative embodiments, the robotic delivery device may be configured to automatically confirm a return upon reaching a merchant location and delivering the return item. In this embodiment, returns may be performed outside of a merchants operating hours, allowing a merchant to retrieve returns upon reopening.

In one embodiment, the robotic delivery device may be connected to a centralized server via wireless connection such as a Wi-Fi network. Upon delivering a return item, the robotic delivery device may transmit an indication of a successful delivery to the centralized server. In one embodiment, the indication may include the product and order information, information from the return packaging, and a user identifier.

A centralized server may receive the delivery indication and update a user account accordingly. Specifically, an order corresponding to the return item may be identified and the status of the order may be updated to a “returned” status. Additionally, the server may credit the user account in the amount of item either via monetary means or via merchant or shopping center credit. Additionally, the server may increase the amount of reward points associated with the user account for successful deliveries using the method 400.

Additionally, the method 400 may transmit a notification of a successful delivery to a user (e.g., via mobile application or via SMS or e-mail). In alternative embodiments, the method 400 may additionally transmit additional promotions to the user (e.g., coupons, contests) to encourage the user to continue using the method 400.

FIG. 5 is a flow diagram illustrating a method for initiating and processing automatic shipping returns according to some embodiments of the disclosure.

In step 502, the method 500 displays a user's purchases. In one embodiment, the method 500 may display a list of user purchases via an application installed on a mobile device. Alternatively, or in conjunction with the foregoing, the method 500 may display a list of user purchases via a website. In one embodiment, a list of user purchases may include an image of the item associated with the purchase, order details regarding the purchases, and an indication of whether the

In step 504, the method 500 determines if a user has selected a purchase and, if not, continues to display purchases (step 502). In step 506, the method 500 determines if a return is available for the selected purchase and, if not, continues to display purchases (step 502). If a return is available, the method 500 transmits a request for a return (step 508).

As discussed previously, in some embodiments, the method 500 may transmit a request to a central server to determine whether a return is enabled for a selected purchase. In one embodiment, a selected purchase may be stored by the server and may be associated with return information such as return label. In one embodiment, the server may determine whether the selected purchase is, in fact, available for return using the method 500.

In response, the server may transmit information regarding the return to the user in response to the request for a return. In one embodiment, the server may return a binary response to whether the return is available. In alternative embodiments, the server may return a return label in response to the request.

In step 510, the method 500 generates a return label. In one embodiment, a server may return a binary indication as to whether a return is available for the selected product. In this embodiment, the method 500 may query the server to determine the weight of the selected purchase and may receive the weight of the selected purchase from the server. In alternative embodiments, the method 500 may utilize an average weight of products as discussed previously. Upon receiving the weight of the product, the method 500 may calculate the estimated shipping fee for the selected purchase. The method 500 may then generate a return label for use in returning the selected product and store the shipping label on the mobile device. Alternatively, the method 500 may receive information regarding the return shipping, the information including a pre-calculated shipping label. In this embodiment, the method 500 may receive a shipping label generated by the server.

In one embodiment, the method 500 may allow a user to print the shipping label or transmit the shipping label to another device (e.g., a laptop or desktop computer) via SMS, instant message, e-mail, or other communication medium. The user may then print the shipping label and return the selected item using the generated shipping label.

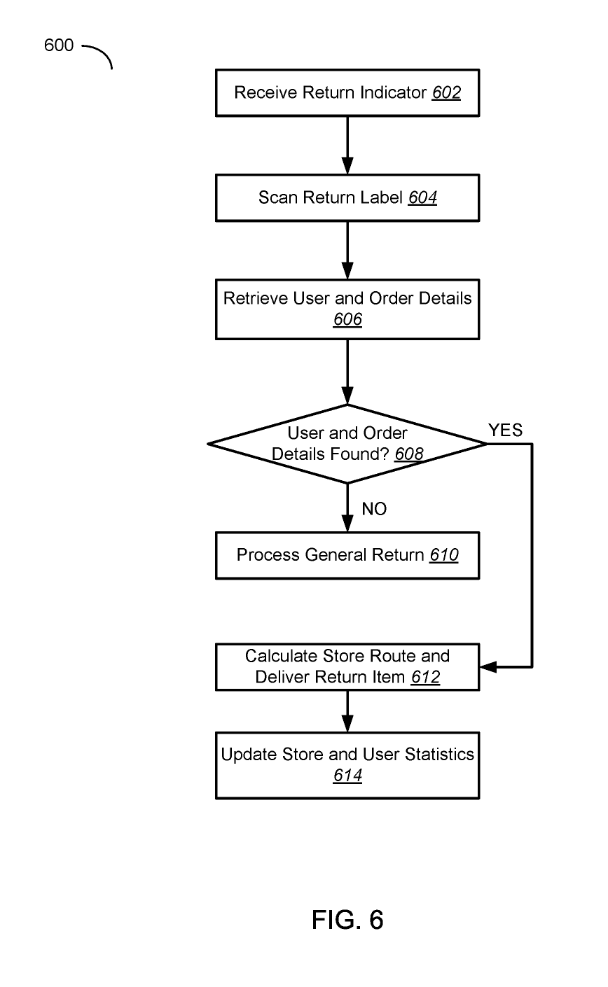

FIG. 6 is a flow diagram illustrating a method for handling automatic shipping returns according to some embodiments of the disclosure.

In step 602, the method 600 receives a return indicator. In one embodiment, receiving a return indicator may comprise receiving a notification from a shipping company that an item was delivered. In one embodiment, the return indicator may be received over a network at an order management system.

In step 604, the method 600 scans the return label of a return item. In one embodiment, scanning the return label may be performed by an employee or device located at the concierge and may comprise scanning a barcode included on the shipping label. In one embodiment, a barcode of a shipping label may include details regarding the returned item such as a universal product code, purchasing user, and other details regarding the purchase and the return.

In step 606, the method 600 retrieves user and order details associated with the return item. In one embodiment, retrieving user and order details may comprise transmitting the information scanned from the return label to a central server and receiving user and order details from the central server in response. For example, the method 600 may receive an identification of a merchant location corresponding to the return item.

In step 610, if the user and order details are not found (step 608), the method 600 may proceed processing a general return. In some embodiments, a concierge employing the method 600 may process both returns made using the methods described in connection with FIGS. 4 and 5 as well as returns made by other means. In the illustrated embodiment, the method 600 may detect between return items including shipping labels generated using methods 400 or 500 and may forward other items for general return procedures. For example, the method 600 may simply route general return items to a centralized storage location for manual review and return processing.

In step 612, if the method 600 identifies a user and an order (step 608), the method 600 may proceed to process the return by calculating a store route. As discussed previously, the method 600 may receive merchant location information from a central server. In one embodiment, merchant location information may comprise a latitude, longitude and floor level of a retail center corresponding to the merchant's location. Alternatively, merchant location information may simply comprise a unique alphanumeric identifier of the merchant.

In response, the method 600 calculates the optimal route from a concierge location to the merchant location. In one embodiment, the method 600 may utilize a pre-stored map of a retail center in order to calculate an optimal route. In many embodiments, the method 600 may be utilized to simultaneously process multiple returns. In these embodiments, the method 600 may calculate a store route that includes multiple merchants. Thus, the method 600 may prioritize the merchant locations based on distance and calculate an optimal route that visits each merchant location in the shortest overall distance. In one embodiment, the method 600 may employ various algorithms to determine an optimal distance such as Dijkstra's algorithm or other shortest path algorithm. As discussed in more detail with respect to FIG. 4, after calculating a store route, the method 600 may proceed to delivery return items to merchant locations.

In step 614, the method 600 then updates store and user statistics. In one embodiment, the method 600 may update statistics associated with a merchant store including statistics such as the total number of return items, the average time period between purchase and return, the dollar amount of return items, the total dollar amount of shipping costs for return items, and various other metrics relating to a store's performance with respect to returned items. These statistics enable further processing to optimize the return procedure on a per-merchant or global basis. In one embodiment, merchants may be given access to return statistics in order to better serve customers and prevent future returns.

Additionally, the method 600 may update statistics regarding users associated with return items. In one embodiment, statistics regarding users may comprise statistics regarding the total number of items returned, the total dollar amount of items returns, the average number of returns per month (or other time period), the average time between purchase and return, and any other metric relating to a user's return activities. Statistics relating to user returns may assist a merchant or retail center in generated targeted offers to users by filtering items that users have returned. Additionally, user statistics may be utilized to prevent fraudulent activity in the event that a user is frequently returning items within a short time period.

FIG. 7 is an illustration of a return package with embedded shipping return labelling according to some embodiments of the disclosure.

As illustrated in FIG. 7, a return package 700 may include a plurality of outer surfaces 706a-d. In one embodiment, surfaces 706a-d may comprise flexible material such as plastic. In alternative embodiments, surfaces 706a-d may comprise sufficiently rigid materials to enable folding of the return package 700 in order to facilitate shipment via mail. Although illustrated as single size, package 700 may be designed in various sizes to accommodate differently sized items and/or items of differing weights. Additionally, package 700 may include one or more handles 710a, 710b used for carrying the package 700 during shopping. Package 700 may additionally include one or more creases 712a-e to enable package 700 to be folded as described herein.

Return package 700 additionally includes an adhesive lining 704. In one embodiment, adhesive lining 704 may comprise an adhesive lining surrounding the upper portion of surfaces 706a-d. in the illustrated embodiment, adhesive lining 704 allows the package 700 to be folded and secured prior to shipping. During operation, a user may fold surfaces 706a-d in a manner whereby adhesive lining 704 is folded on the outer surface of surface 706b. Upon meeting surface 706b, adhesive lining 704 adheres to surface 706b, thus forming a seal to prevent the exit of return items from the return package 700.

Return package 700 additionally includes a return label 702. As illustrated, return label 702 may be placed on a side surface 706b of the package 700. Alternatively, return label 702 may be placed on the bottom surface of the package 700. In alternative embodiments, the package 700 may additionally include merchant logos (not illustrated) on other sides of the package 700. In the illustrated embodiment, the label 702 includes a barcode 708. In one embodiment, barcode 708 may represent a universal product code. In alternative embodiments, barcode 708 may be a QR code or other representation of a product code. In alternative embodiments, barcode 708 may additionally include user-specific information or merchant-specific information as discussed previously. In some embodiments, return label 702 may be generated as discussed in connection with FIGS. 4 through 6.

The subject matter described above may be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The description presented above is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method for providing automatic return shipping, the method comprising:
receiving a purchase request, the purchase request including an identification of a product and a user identifier;
generating a return label upon receiving the purchase request;
providing the return label to a user;
receiving a return item from a user, wherein the return item includes the return label;
scanning the return label to determine a merchant identification, wherein the merchant identification includes a location of the merchant; and
delivering the return item to the merchant based on the location of the merchant.

2. The method of claim 1 wherein receiving a purchase request comprises receiving a purchase request at a point of sale terminal.

3. The method of claim 1 wherein generating a return label based on the purchase request comprises:
receiving a request for a return label from the user via a mobile application;
calculating the weight of the product;
generating a return label based on the weight of the product; and
transmitting the return label to the user.

4. The method of claim 3 wherein calculating the weight of the product comprises calculating the average weight of a plurality of products offered for sale by a merchant.

5. The method of claim 3 wherein transmitting the return label to the user comprises transmitting the return label using an SMS or electronic mail message.

6. The method of claim 1 wherein generating a return label upon receiving the purchase request comprises selecting a return package including the return label from a set of return packages and wherein providing the return label to a user comprises providing the return package including the return label to a user at a concierge.

7. The method of claim 1 wherein generating a return label upon receiving the purchase request comprises receiving an identification of a product from a user wherein the identification of a product from comprises a universal product code and wherein providing the return label to a user comprises providing the return package including the return label to a user at a concierge.

8. The method of claim 1 wherein delivering the return item to the merchant based on the location of the merchant comprises delivering the return item using a robotic delivery device.

9. The method of claim 8 further comprising calculating a route to the merchant based on the merchant location, wherein the route is calculated based on pre-defined map.

10. The method of claim 1 wherein providing the return label to a user comprises providing a return package to the user, the return package including the return label.

11. A system for providing automatic return shipping, the system comprising:
an order management system configured to:
receive a purchase request, the purchase request including an identification of a product and a user identifier;
generate a return label upon receiving the purchase request;
provide the return label to a user; and
receive a return item from a user, wherein the return item includes the return label; and
a scanner communicably coupled to the order management system configured to:
scan the return label to determine a merchant identification, wherein the merchant identification includes a location of the merchant; and
schedule the delivery of the return item to the merchant based on the location of the merchant.

12. The system of claim 11 wherein receiving a purchase request comprises receiving a purchase request at a point of sale terminal.

13. The system of claim 11 wherein generating a return label based on the purchase request comprises:
receiving a request for a return label from the user via a mobile application;
calculating the weight of the product;
generating a return label based on the weight of the product; and
transmitting the return label to the user.

14. The system of claim 13 wherein calculating the weight of the product comprises calculating the average weight of a plurality of products offered for sale by a merchant.

15. The system of claim 13 wherein transmitting the return label to the user comprises transmitting the return label using an SMS or electronic mail message.

16. The system of claim 11 wherein generating a return label upon receiving the purchase request comprises selecting a return package including the return label from a set of return packages and wherein providing the return label to a user comprises providing the return package including the return label to a user at a concierge.

17. The system of claim 11 wherein generating a return label upon receiving the purchase request comprises receiving an identification of a product from a user wherein the identification of a product from comprises a universal product code and wherein providing the return label to a user comprises providing the return package including the return label to a user at a concierge

18. The system of claim 11 further comprising a robotic delivery device and wherein delivering the return item to the merchant based on the location of the merchant comprises delivering the return item using the robotic delivery device.

19. The system of claim 18 further comprising calculating a route to the merchant based on the merchant location, wherein the route is calculated based on pre-defined map.

20. The system of claim 10 wherein providing the return label to a user comprises providing a return package to the user, the return package comprising:
a plurality of side surfaces and a bottom surface connected to the side surfaces at a substantially perpendicular angle;
an adhesive lining circling an upper portion of at least one of said side surfaces; and
a return label positioned on one of said side surfaces, wherein said return label includes at least one bar code enabling shipment of the package.
